(19) United States
(12) Patent Application Publication
(10) Pub. No.: US 2023/0132917 A1
(43) Pub. Date: May 4, 2023

(54) POLYMER INTERLAYERS HAVING REDUCED YELLOW COLOR

(71) Applicant: Solutia Inc., St. Louis, MO (US)

(72) Inventors: Bert Jozef Campo, Melle (BE); Olivier Etienne Hilaire Geert Verkinderen, Wichelen (BE); Howard D. Booth, JR., Westfield, MA (US)

(73) Assignee: Solutia Inc., St. Louis, MO (US)

(21) Appl. No.: 17/760,488

(22) PCT Filed: Mar. 5, 2021
(86) PCT No.: PCT/US2021/020981

§ 371 Date: Aug. 10, 2022

Related U.S. Application Data
(60) Provisional application No. 62/988,939, filed on Mar. 13, 2020.

(51) Int. Cl. B32B 17/10; B32B 27/08; B32B 27/30; B32B 27/36

(52) U.S. Cl. CPC B32B 17/10761; B32B 27/08; B32B 17/10036; B32B 27/30; B32B 27/36; B32B 17/10651; B32B 17/10605; B32B 2307/412; B32B 2309/105; B32B 2307/4026; B32B 2307/414

(57) ABSTRACT

Polymer interlayers that have low color for multiple layer panels are disclosed. The use of polymer interlayers having low color provide multiple layer panels with a visibly neutral (low yellow) color as well as high visible light transmission.

### BACKGROUND OF THE INVENTION

### 1. Field of the Invention

This disclosure is related to the field of polymer interlayers for multiple layer panels and multiple layer panels having at least one polymer interlayer sheet. Specifically, this disclosure is related to the field of polymer interlayers having low color and multiple layer panels comprising the polymer interlayers that have low color, particularly low yellow color.

### 2. Description of Related Art

Multiple layer panels are generally panels comprised of two sheets of a substrate (such as, but not limited to, glass, polyester, polyacrylate, or polycarbonate) with one or more polymer interlayers sandwiched therebetween. The laminated multiple layer glass panels are commonly utilized in architectural window applications and in the windows of motor vehicles and airplanes. These applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may, among other things, give the glass a higher sound insulation rating, reduce UV and/or IR light transmission, or enhance the aesthetic appeal of the associated window. The interlayer may be a single layer, a combination of two or more single layers, a multilayer that has been coextruded, a combination of at least one single layer and at least one multilayer, or a combination of multilayer sheets.

Laminated safety glass, or multiple layer glass panels, is used in many different applications in the transportation industry, including automotive, railroad, and aviation vehicles. Polymer interlayers used in laminated safety glass have also been used in architectural or building applications as, for example, panels for windows in buildings or stadiums, balustrades, decorative panels (such as in offices), and the like. Such applications allow additional creativity by incorporating color and other decorative features into a design.

Interlayers for windows, windshields and other multiple layer glass panel applications are generally produced by mixing a polymer resin (or resins) such as poly(vinyl butyral) with one or more plasticizers and other additives and melt processing the mix into a sheet by any applicable process or method known to one of skill in the art, including, but not limited to, extrusion. For multiple layer interlayers comprising two or more layers, the layers may be combined by processes such as co-extrusion and lamination. Other additional ingredients may optionally be added for various other purposes. After the interlayer sheet is formed, it is typically collected and rolled for transportation and storage and for later use in the multiple layer glass panel, as discussed below.

In the process of making the PVB interlayers, organic compounds may be added to the formulations along with the resins and plasticizers (and any other additives), and these organic compounds often have a certain color or some level of color. During the extrusion of the interlayer, the interlayer may become more colored (such as yellow) or additional color may be added (for example, the process temperatures may cause some additional color), and this sometimes results in an interlayer that has a slight yellow color.

In the past, additives such as stabilizers and optical brighteners have been added to the formulations in an attempt to reduce or eliminate the yellowness or yellow color. Additionally, attempts have been made to limit the contributions of the individual components to the yellowness by modifying the manufacturing process, but it is not practical or even possible to eliminate all yellowness or yellow color in this way.

Current commercially available laminated safety glazings having clear PVB interlayers typically have a yellowness index (YI) of at least about 2 to (up to a maximum of about 10) (where YI is measured and calculated according to ASTM E1348 and E313 using Illuminant C, at an observer angle of 2 degrees (formerly D1925) on a nominal thickness of 6.3 mm of PVB sheet, pressed between two plates of standard clear float glass, as further described below), and the interlayers with the lowest yellow color (that is, the color closest to being color neutral), measured in the CIELab color space, have a* values of about −1.0 or lower and b* values of greater than 2.0, greater than 2.5, or greater than 3.0 (as measured and calculated by ASTM methods E1348 and E308 for color on a nominal thickness of 6.3 mm of PVB sheet). These commercially available glazings would generally have L* values of greater than about 96 (as measured by ASTM methods E1348 and E308 for color on a nominal thickness of 6.3 mm of PVB sheet).

Contemplated polymer interlayers include, but are not limited to, poly(vinyl)acetal resins such as poly(vinyl butyral) (PVB). Multilayer laminates can include multiple layer glass panels and multilayer polymer films. In certain embodiments, the multiple polymer films in the multilayer laminates may be laminated together to provide a multilayer film or interlayer. In certain embodiments, these polymer films may have coatings, such as metal, silicone or other applicable coatings known to those of ordinary skill in the art. The individual polymer films which comprise the multilayer polymer films may be laminated together using an adhesive as known to those of ordinary skill in the art.

The following offers a simplified general description of the manner in which multiple layer glass panels are generally produced in combination with the interlayers. First, at least one polymer interlayer sheet (single or multilayer) is placed between two substrates, such as glass panels, and any excess interlayer is trimmed from the edges, creating an assembly. It is not uncommon, particularly in architectural and/or building applications such as windows in buildings, interior or exterior panels, balustrades, and the like, for multiple polymer interlayer sheets or a polymer interlayer sheet with multiple layers (or a combination of both) to be placed within the two substrates creating a multiple layer glass panel with multiple polymer interlayers. Then, air is removed from the assembly by an applicable process or method known to one of skill in the art, e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by, for example, a high temperature and pressure lamination process known to one of ordinary skill in the art such as, but not limited to, autoclaving, or by other processes known to one of ordinary skill in the art.

One of the problems in the manufacture of multilayer laminate glass panels is the presence of various optical defects and/or undesirable color in the final unitary structure or laminate, such as the window or panel. The multiple layer glass panels need to be free of optical defects and have consistent color or tone. Additionally, the multiple layer glass panels need to be aesthetically pleasing, that is, the glass panels cannot have undesirable manufacturing defects. It is important to maintain the high optical standards when adding new features and functionality to the glass panels.

Good optical quality and color tone is particularly important where the multiple layer glass panels or glazings are those used in applications which require higher levels of optical or visual quality, such as windows. In an attempt to improve the multiple layer glass panels used in windows and other glazing applications, and particularly in an attempt to make them more aesthetically pleasing to the consumer, new colors and features are constantly being developed. There is a need for improved interlayers for use in the windows and other panels where a low yellow color or neutral color appearance is desirable.

There is also a need for improved interlayers with very low color, and particularly low yellow color. There is also a need for interlayers having a low yellow color or neutral color appearance that can be used in combination with other interlayers and different glass types in laminated glass panels.

Accordingly, there is a need in the art for the development of an interlayer having lower color tone or less yellowness while maintaining high visible light transmission for use in extra clear glazing applications without a reduction in optical, mechanical, and performance characteristics of an interlayer.

### SUMMARY OF THE INVENTION

Because of these and other problems in the art, described herein, among other things is a polymer interlayer that has improved color, such as an improved combination of L*, a* and b* values as well as improved luminous transmittance (% T). In an embodiment, an interlayer comprises: poly(vinyl butyral) resin, a plasticizer, and at least one colorant, wherein the interlayer has improved properties such as low color and high visible light transmission while also maintaining low yellowness index (YI). In an embodiment, a poly(vinyl butyral) interlayer comprises: poly(vinyl butyral) resin and at least one plasticizer, wherein the interlayer has color coordinates L*, a* and b*, when measured on a PVB sample having a thickness of 6.3 mm (as measured according to ASTM E1348 III. D65/10° Obs. CIELab), of L*>94,−2.5<a*<0 and 0<b*<2.5, and a Luminous Transmittance (% T, measured according to ASTM D1003) of at least 85%.

In an embodiment, a poly(vinyl butyral) interlayer comprises: poly(vinyl butyral) resin and at least one plasticizer, wherein the interlayer has color coordinates a* and b*, when measured on a sample having a thickness of 6.3 mm (as measured according to ASTM E1348 III. D65/10° Obs. CIELab), of L*>94,−2.5<a*<−1.0 and 0<b*<2.5, and a luminous transmittance (% T) of at least 85%.

In an embodiment, a poly(vinyl butyral) interlayer comprises: poly(vinyl butyral) resin and at least one plasticizer, wherein the interlayer has color coordinates a* and b*, when measured on a sample having a thickness of 6.3 mm (as measured according to ASTM E1348 III. D65/10° Obs. CIELab), of L*>94, −2.5<a*<−1.1 and 0<b*<2.5, and a luminous transmittance (% T) of at least 85%.

In an embodiment, a poly(vinyl butyral) interlayer comprises: poly(vinyl butyral) resin and at least one plasticizer, wherein the interlayer has color coordinates a* and b*, when measured on a sample having a thickness of 6.3 mm (as measured according to ASTM E1348 III. D65/10° Obs. CIELab), of L*>94, −2.5<a*<−1.2 and 0<b*<2.5, and a luminous transmittance (% T) of at least 85%. In embodiments, −2.5<a*<−1.1 and 0<b*<2.5, or −2.4<a*<−1.2 and 0<b*<2.5, or −2.3<a*<−1.2 and 0<b*<2.4, or −2.2<a*<−1.3 and 0.5<b*<2.4, or −2.1<a*<−1.3 and 0.5<b*<2.3, or −2.0<a*<−1.5 and 1.0<b*<2.0.

In an embodiment, a poly(vinyl butyral) interlayer comprises: poly(vinyl butyral) resin and at least one plasticizer, wherein the interlayer has color coordinates a* and b*, when measured on a sample having a thickness of 6.3 mm (as measured according to ASTM E1348 III. D65/10° Obs. CIELab), of L*>94, −2.5<a*<−1.0 and 0<b*<2.5, and a luminous transmittance (% T) of at least 86%.

In an embodiment, a poly(vinyl butyral) interlayer comprises: poly(vinyl butyral) resin and at least one plasticizer, wherein the interlayer has color coordinates a* and b*, when measured on a sample having a thickness of 6.3 mm (as measured according to ASTM E1348 III. D65/10° Obs. CIELab), of L*>94, −2.5<a*<−1.1 and 0<b*<2.5, and a luminous transmittance (% T) of at least 86%.

In an embodiment, a poly(vinyl butyral) interlayer comprises: poly(vinyl butyral) resin and at least one plasticizer, wherein the interlayer has color coordinates a* and b*, when measured on a sample having a thickness of 6.3 mm (as measured according to ASTM E1348 III. D65/10° Obs. CIELab), of L*>94, −2.5<a*<−1.2 and 0.5<b*<2.5, and a luminous transmittance (% T, measured according to ASTM D1003) of at least 86%.

In embodiments, the poly(vinyl butyral) interlayer has color coordinates a* and b*, when measured on a sample having a thickness of 6.3 mm (as measured according to ASTM E1348 III. D65/10° Obs. CIELab), of −2.3<a*<−1.2 and 0<b*<2.4, or −2.2<a*<−1.3 and 0.4<b*<2.3, or −1.9<a*<−1.4 and 1.5<b*<2.0.

In embodiments, the poly(vinyl butyral) interlayer has color coordinates a* and b*, when measured on a sample having a thickness of 3.8 mm (as measured according to ASTM E1348 III. D65/10° Obs. CIELab), of −1.5<a*<−0.95 and 0<b*<1.5, or −1.5<a*<−1.0 and 0.2<b*<1.5 or −1.3<a*<−1.0 and 0.8<b*<1.5, and L*>95 when measured on a PVB with thickness of 3.8 mm (as measured according to ASTM E1348 III. D65/10° Obs. CIELab).

In embodiments, the poly(vinyl butyral) interlayer has a luminous transmittance (% T) of at least 89%, when measured on a PVB thickness of 3.8 mm (as measured according to ASTM D1003).

In embodiments, the interlayer has color coordinates a* and b*, when measured on poly(vinyl butyral) having a thickness of 1.52 mm (as measured according to ASTM E1348 III. D65/10° Obs. CIELab), of −0.65<a*<−0.45 and 0.1<b*<0.8, or −0.6<a*<−0.4 and 0.4<b*<0.8, and L*>95.

In embodiments, the interlayer has a luminous transmittance (% T) of at least 91%, when measured on a sample having a PVB thickness of 1.52 mm (as measured according to ASTM D1003).

In embodiments, the interlayer has color coordinates L*, a* and b*, when measured on a sample having a thickness of 0.76 mm (as measured according to ASTM E1348 III. D65/10° Obs. CIELab), of L*>96,−0.35<a*<−0.25 and 0.05<b*<0.55.

In embodiments, a laminate comprising the interlayer has a luminous transmittance (% T) of at least 90% when measured on a laminate having a PVB interlayer with a thickness of 0.76 mm and two layers of low iron glass each having a thickness of 4 mm, where the poly(vinyl butyral) layer has a luminous transmittance (% T) of at least 91.5%, when measured on a PVB thickness of 0.76 mm (as measured according to ASTM D1003).

In embodiments, the interlayer is a multilayer interlayer having at least two layers, or the interlayer is a multilayer interlayer having at least three layers, or the interlayer is a multilayer interlayer having more than three layers.

In another embodiment, a transparent multiple layer panel comprises: a first glass substrate, and a second glass substrate, wherein the first and second glass substrates consist of extra clear float glass, and the poly(vinyl butyral) interlayer previously described between the first and second substrates.

In embodiments, the multiple layer panel has a Luminous Transmittance (% T) of at least 86%, or at least 87%, or at least 88%, or at least 89%, or at least 90% (when measured according to ASTM D1003). The % T will be affected by glass color, type and thickness in addition to the interlayer thickness.

In embodiments, the interlayer is a multilayer interlayer having at least one layer of 0.76 mm thickness, or the interlayer is a multilayer interlayer having at least two layers of 0.76 mm thickness.

In an additional embodiment, a method for making an improved color poly(vinyl butyral) sheet comprises: providing a poly(vinyl butyral) resin; providing a plasticizer; providing at least one colorant in an amount sufficient to reduce the yellow color aspect of the poly(vinyl butyral) sheet; melt blending the poly(vinyl butyral) resin, the plasticizer and the colorant to create a poly(vinyl butyral) melt blend; and extruding the poly(vinyl butyral) melt blend into a poly(vinyl butyral) sheet; wherein the poly(vinyl butyral) sheet has color coordinates a* and b*, when measured on a sheet having a thickness of 6.3 mm (as measured according to ASTM E1348 III. D65/10° Obs. CIELab), of L*>94, −2.5<a*<0 and 0<b*<2.5. In other embodiments, the poly(vinyl butyral) sheet has color coordinates and % T within any of the previously described ranges.

In embodiments, the interlayer comprises a single layer, and in other embodiments, the interlayer comprises multiple layers, such as two layers, three layers, or four or more layers.

In certain embodiments, the rigid substrate (or substrates) is glass. In other embodiments, the panel may further comprise a photovoltaic cell, with the interlayer encapsulating the photovoltaic cell. In other embodiments, the panel may further comprise a film, with or without coatings, such as reflective coatings or coatings that absorb UV.

### BRIEF DESCRIPTION OF THE DRAWINGS

FIG. 1 provides a graphical illustration of a* and b* coordinates for commercial PVB interlayers (measured at a nominal thickness of 6.3 mm) in a laminated glazing with standard clear float glass and low iron clear float glass.

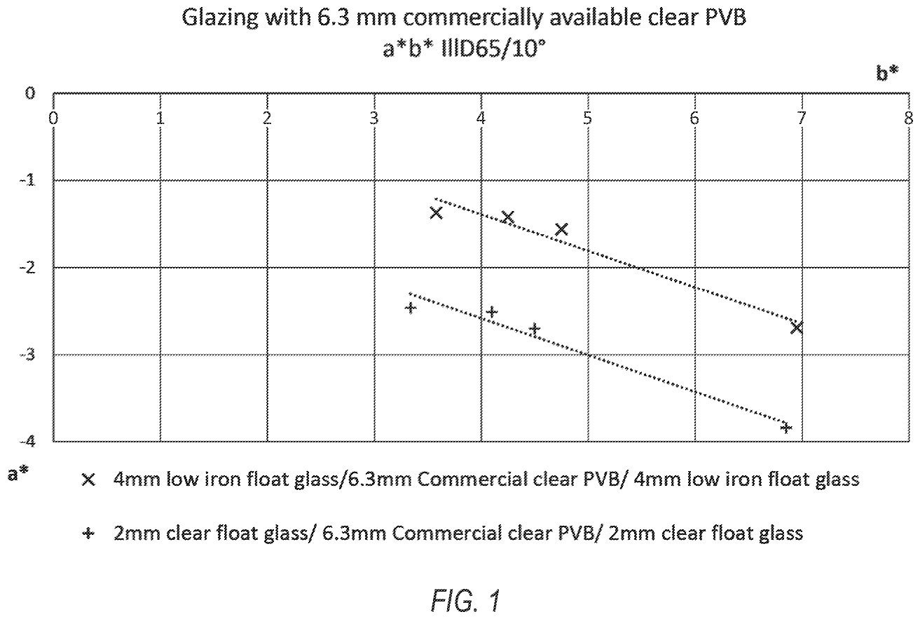

FIG. 2 provides a graphical illustration of a* and b* coordinates for commercially available and comparative low YI PVB interlayers (measured at a nominal thickness of 6.3 mm) in a laminated glazing with standard clear float glass.

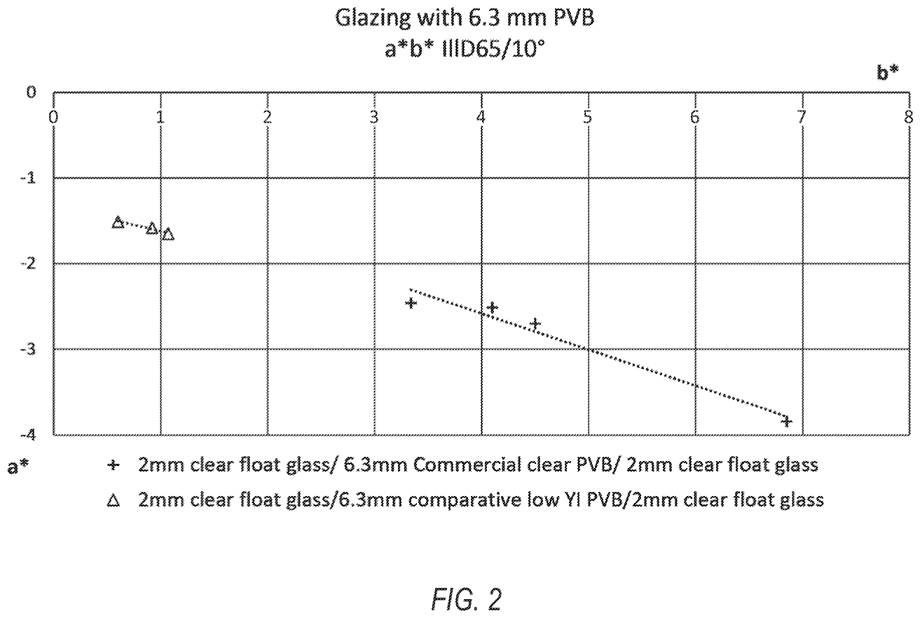

FIG. 3 provides a graphical illustration of a* and b* coordinates for commercially available and disclosed PVB interlayers (measured at a nominal thickness of 6.3 mm) in a laminated glazing with low iron clear float glass and for the disclosed PVB interlayers the a* and b* coordinates on samples without any glass.

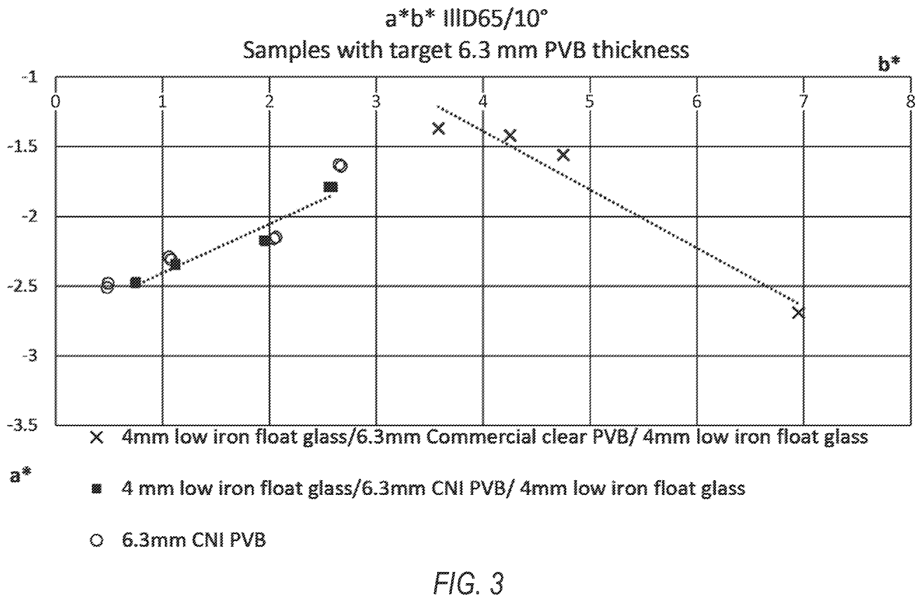

FIG. 4 provides a graphical illustration of a* and b* coordinates for four different disclosed PVB interlayers in laminated glazings with low iron glass, measured at a nominal thicknesses of 0.76 mm, 1.52 mm, 3.8 mm and 6.3 mm.

FIG. 5 provides a graphical illustration of the a* and b* coordinates for four different disclosed PVB interlayers, measured at nominal thicknesses of 0.76 mm, 1.52 mm, 3.8 mm and 6.3 mm.

FIG. 6 provides a graphical illustration of the a* coordinate for four different disclosed PVB formulations compared to several reference PVB interlayers at different nominal thicknesses.

FIG. 7 provides a graphical illustration of the b* coordinate for four different disclosed PVB formulations compared to several reference PVB interlayers at different nominal thicknesses.

FIG. 8 provides a graphical illustration of the % T of four different disclosed PVB formulations compared to several reference PVB interlayers at different nominal PVB thicknesses.

FIG. 9 provides a graphical illustration of the color tuning by adding different colorants or different concentrations of colorants and one target area for a* and b* coordinates to provide a visually color neutral (low yellow color) interlayer.

### DESCRIPTION OF THE PREFERRED EMBODIMENT(S)

Described herein, among other things, are interlayers comprised of a thermoplastic resin, a plasticizer, and at least one additive, wherein the interlayer has a low yellowness and color neutral appearance, good optical properties and minimal change or reduction in other properties such that the other properties are acceptable.

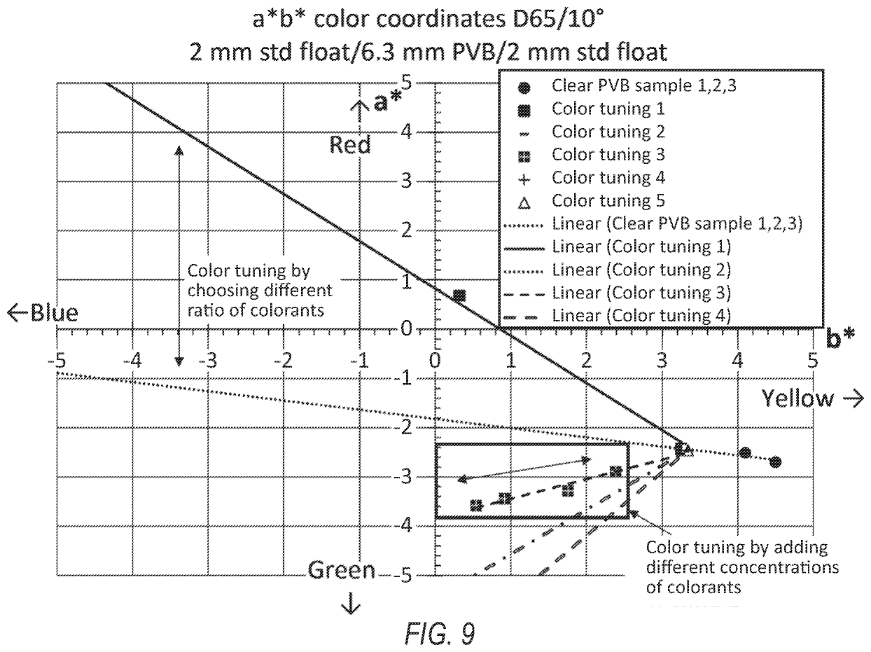

The presence of a certain amount of yellowness or yellow color in the polymer (such as PVB) interlayer may be visually objectionable to customers, particularly when an extra clear glazing is to be used in an application, such as an architectural application. Many commercially available PVB interlayers have yellow color that is higher than desired for use in extra clear glazings. The inventors have found that it is possible to reduce the yellowness (or lower the level of yellow color) to produce a more color neutral polymer material by the addition of colorants in a ratio and concentration selected such that the resulting color of the polymer (PVB) has little or no noticeable yellow color. By adding certain colorants to the polymer interlayer, it is possible to change the a* and b* values of the polymer sheet, as displayed in FIG. 9 and as further described below, while producing an interlayer that also has high visible light transmission (or where the visible light transmission is not adversely affected by the addition of the colorants) and maintains an L* value that is acceptable.

In an embodiment, a poly(vinyl butyral) interlayer comprises: poly(vinyl butyral) resin and at least one plasticizer, wherein the interlayer has color coordinates L*, a* and b*, when measured on an interlayer having a thickness of 6.3 mm (as measured according to ASTM E1348 III. D65/10° Obs. CIELab), of L*>94, −2.5<a*<0 and 0<b*<2.5. In embodiments, the interlayer has a thickness of about 0.76 mm, or about 1.52 mm, or about 3.8 mm or about 6.3 mm or more. In embodiments, the interlayer has color coordinates a* and b*, when measured on an interlayer having a thickness of 6.3 mm (as measured according to ASTM E1348 III. D65/10° Obs. CIELab), of −2.5<a*<−1.0 and 0.5<b*<2.5, or −2.5<a*<−1.1 and 0.5<b*<2.5, or −2.5<a*<−1.2 and 0.5<b*<2.5, or −2.5<a*<−1.3 and 0.5<b*<2.5, or −2.5<a*<−1.4 and 0.5<b*<2.5, or −2.5<a*<−1.5 and 0.5<b*<2.5. In embodiments, −2.4<a*<−1.2 and 0<b*<2.5, or −2.3<a*<−1.2 and 0<b*<2.4, or −2.2<a*<−1.3 and 0.5<b*<2.4, or −2.1<a*<−1.3 and 0.5<b*<2.3, or −2.0<a*<−1.5 and 1.0<b*<2.0. Other ranges of L*, a* and b* are also applicable as desired and required for the particular use or application.

In embodiments, a multiple layer panel has L* 94 when measured on a laminate having a PVB interlayer with a thickness of 6.3 mm (as measured according to ASTM E1348 III. D65/10° Obs. CIELab). In embodiments, the multiple layer panel has L* 96 when measured on a laminate having a PVB interlayer with a thickness of 0.76 mm (as measured according to ASTM E1348 μl. D65/10° Obs. CIELab).

In embodiments, the interlayer is a multilayer interlayer having at least two layers, or the interlayer is a multilayer interlayer having at least three layers, or the interlayer is a multilayer interlayer having more than three layers.

In embodiments, the multiple layer panel has a Luminous Transmittance (% T) of at least 86 (when measured according to ASTM D1003).

The use of a poly(vinyl acetal) resin(s), such as poly(vinyl butyral resin, a plasticizer, and at least one colorant (in an appropriate amount), when melt-extruded, creates an interlayer having a color neutral or low yellow color appearance without sacrificing other optical or physical characteristics. As used herein, “lower color”, “lower yellow color”, “neutral color” and “color neutral” mean having less yellow color appearance and a color centered around certain a*, b* and L* values so that the sheet has low yellow color and also good luminous transmittance, preferably having b*>0 and a*<0 as shown in FIG. 9. The terms lower color, lower yellow color, neutral color and color neutral all refer to the visual yellowness or yellow color (or lack of) and may be used interchangeably throughout this description.

As previously described, attempts to provide a less yellow appearance to interlayers have been made by addition of additives such as stabilizers and optical brighteners to the formulations in an attempt to reduce the yellowness or yellow color. Examples of previous attempts to reduce yellowness can be found, for example, in Liu, R., He, B. & Chen, X. 2008. Degradation of poly(vinyl butyral) and its stabilization by bases. Polymer Degradation and Stability 93(4): 846-853; U.S. Publication No. 20140371356 Al; and U.S. Pat. No. 5,573,842. Addition of an optical brightener, which is often considered a ‘blue’ compound, to compensate for or reduce the yellow color often makes the resultant polymer look green. Additionally, attempts have been made to limit the contributions of the individual components to the yellowness by modifying the manufacturing process, but it is not practical to eliminate all yellowness or yellow color in this way. Addition of some pigments, dyes or colorants, or too much of the pigments, dyes and/or colorants, while sometimes reducing the yellow color or yellowness, can also result in lowering the luminous transmittance (% T) beyond desirable or acceptable levels for certain applications.

The inventors have discovered that it is possible to alter the color (as determined by L*, a* and b* values) to reduce the yellow appearance (as determined by b* and YI value) while also maintaining the % T of at least 85% and having a high L* value to produce a more color neutral PVB material. By the addition of certain colorants with the other raw materials (such as PVB and plasticizer) in a ratio and concentration selected such that the resulting color of the PVB has low visual color (yellow) appearance and % T>86% (when measured at a nominal PVB thickness of 6.3 mm as described herein), an improved interlayer is produced. A polymer interlayer having good optical quality and improved color (lower color or more color neutral) may be produced. By using the addition of certain colorants, it is possible to control the L*, a* and b* values and % T of the PVB sheet, as further described below.

FIG. 9 shows how the PVB color can be tuned or changed by adding certain additives, such as colorants. As shown in FIG. 9, the color coordinates can be controlled and, if additives are added in an appropriate amount, a polymer sheet having a neutral color can be produced wherein a* is less than 0 and b* is greater than 0. By adding more or less of certain colorants, the a* and b* values can be tuned (increased or decreased) to reach optimal levels as desired or required by the application.

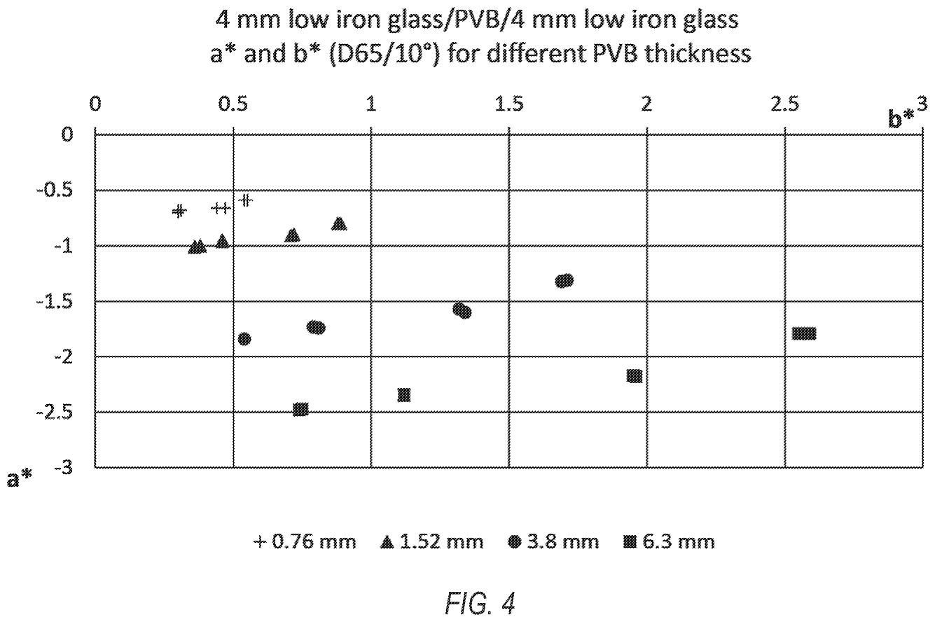

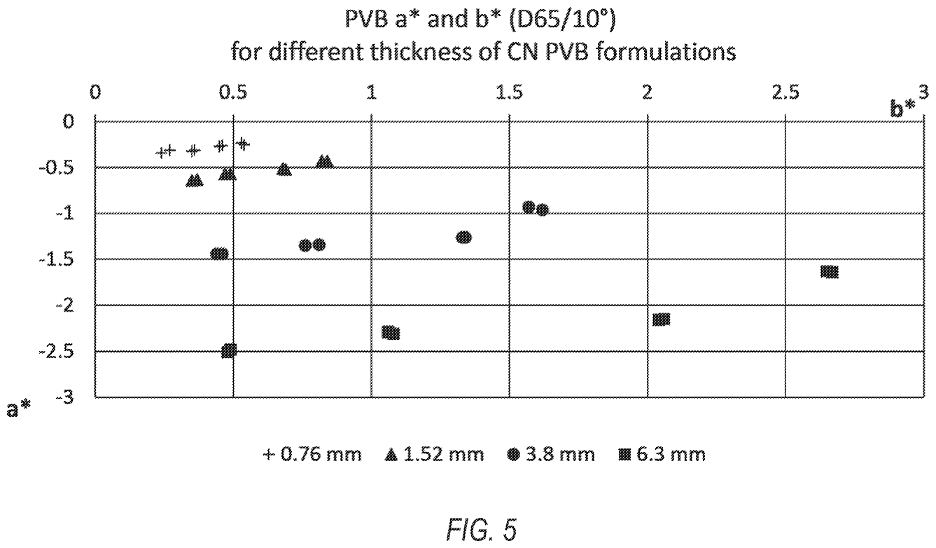

The PVB samples were laminated with 2 mm thick standard float glass and a* and b* values were measured as described herein. As shown by FIGS. 4 and 5, for various nominal PVB thicknesses of 0.76 mm to 6.3 mm, it is possible to produce an interlayer having lower or more neutral color. The interlayers were measured at various thicknesses as indicated in the Tables.

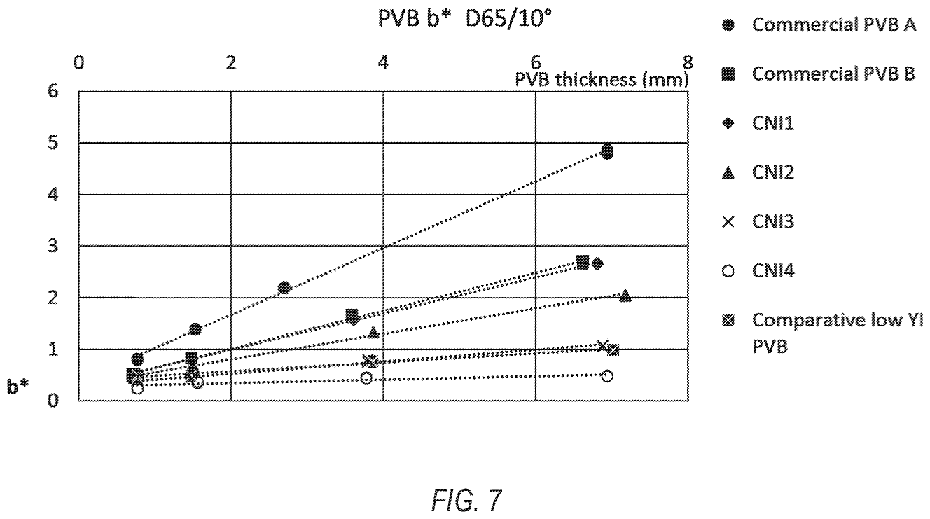

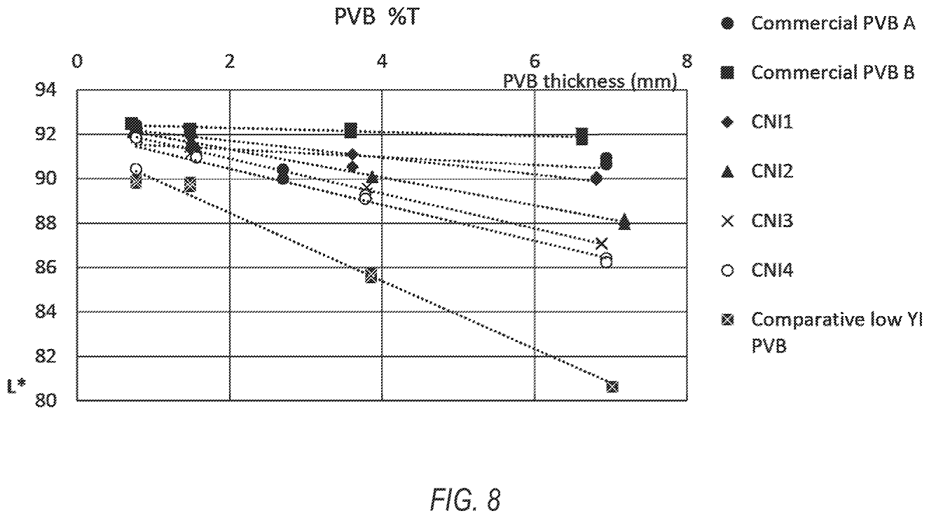

The differences, and thus the improvements, in color are more readily discernible at higher PVB thickness levels. Having the thicker PVB leads to higher a* and b* and therefore more pronounced color differentiation as shown in FIGS. 4 to 8. If there are slight or small color differences between the samples, they may only be distinguishable at higher PVB thicknesses.

The presence of glass, even if it is low iron glass, adds color to a multilayer panel. This is demonstrated by the a* values of laminated glazings with PVB samples as shown in FIG. 4 compared to the a* values of the same PVB samples without glass in FIG. 5. The a* values of the PVB samples in glass are consistently lower as compared to the a* values of the PVB samples without glass. By carefully controlling the types and amounts of colorants, the final PVB color can be tuned or controlled to be less yellow and more color neutral. Adding higher concentrations of colorant will lead to lower L* and % T values, which may be undesirable for some applications where high luminous transmission (% T of at least 80%, or at least 85%) is necessary.

As shown in FIGS. 4 to 8, the a* and b* data shows that the response of the color measurement is more pronounced at higher PVB thickness by plotting a* and b* coordinates for the different formulations at the respective thicknesses. At 6.3 mm nominal thickness, color differences are visible between some interlayers where they are not visible or almost indistinguishable (or samples have almost the same a* and b* values) in samples having a nominal thickness of 0.76 mm.

Some terminology used throughout this application will be explained to provide a better understanding of the invention. The terms “polymer interlayer sheet,” “interlayer,” and “polymer melt sheet” as used herein, generally may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present disclosure, a multilayered interlayer comprises at least two polymer layers (e.g., a single layer or multiple layers co-extruded) disposed in direct contact with each other, wherein each layer comprises a polymer resin, as detailed more fully below. As used herein, “skin layer” generally refers to outer layers of the multilayered interlayer and “core layer” generally refers to the inner layer(s). Thus, one exemplary embodiment would be: skin layer//core layer//skin layer. It should be noted, however, further embodiments include interlayers having more than three layers (e.g., 4, 5, 6, or up to 10 individual layers). Additionally, any multilayer interlayer utilized can be varied by manipulating the composition, thickness, or positioning of the layers and the like. For example, in one trilayer polymer interlayer sheet, the two outer or skin layers may comprise poly(vinyl butyral) (“PVB”) resin with a plasticizer or mixture of plasticizers, while the inner or core layer may comprise the same or different PVB resin or different thermoplastic material with a plasticizer and/or mixture of plasticizers. Thus, it is contemplated that the skin layers and the core layer(s) of the multilayered interlayer sheets may be comprised of the same thermoplastic material or different thermoplastic materials. Either or both layers may include additional additives as known in the art, as desired.

Although the embodiments described below refer to the polymer resin as being PVB, it would be understood by one of ordinary skill in the art that the polymer may be any poly(vinyl acetal) polymer suitable for use in a multiple layer panel. PVB is particularly desirable when used in conjunction with the interlayers of this disclosure for use in windows and other glazing applications.

Some common components found in an interlayer, both generally and in interlayers of the present disclosure, and the formation thereof will be discussed. The PVB resin is produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Wade, B. 2016, Vinyl Acetal Polymers, Encyclopedia of Polymer Science and Technology. 1-22 (online, copyright 2016 John Wiley & Sons, Inc.), the entire disclosures of which are incorporated herein by reference. The resin is commercially available in various forms, for example, as Butvar® Resin from Eastman Chemical Company.

As used herein, residual hydroxyl content (calculated as PVOH) refers to the amount of hydroxyl groups remaining on the polymer chains after processing is complete. For example, PVB can be manufactured by hydrolyzing poly(vinyl acetate) to PVOH, and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished poly(vinyl butyral) resin, there typically will be residual acetate groups (as vinyl acetate groups) and residual hydroxyl groups (as vinyl hydroxyl groups) as side groups on the polymer chain. As used herein, residual hydroxyl content is measured on a weight percent basis per ASTM 1396.

In various embodiments, the poly(vinyl butyral) resin comprises about 8 to about 35 weight percent (wt. %) hydroxyl groups calculated as PVOH, depending on the desired properties of the interlayer. In embodiments, the resin (or at least one resin) may comprise about 10 to 30 wt. %, or about 15 to 25 wt. % hydroxyl groups calculated as PVOH, although other amounts are possible depending on the desired properties. The resin can also comprise less than 15 wt. % residual ester groups, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, such as butyraldehyde acetal, but optionally being other acetal groups, such as a 2-ethyl hexanal acetal group, or a mix of butyraldehyde acetal, iso-butyraldehyde acetal and 2-ethyl hexanal acetal groups (see, for example, U.S. Pat. No. 5,137,954, the entire disclosure of which is incorporated herein by reference).

For a given type of plasticizer, the compatibility of the plasticizer in the polymer is largely determined by the hydroxyl content of the polymer. Polymers with greater residual hydroxyl content are typically correlated with reduced plasticizer compatibility or capacity. Conversely, polymers with a lower residual hydroxyl content typically will result in increased plasticizer compatibility or capacity. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content between multiple interlayers.

The PVB resin (or resins) of the present disclosure typically has a molecular weight of greater than 50,000, about 50,000 to about 500,000 Daltons, about 70,000 to about 500,000 Daltons, about 80,000 to about 250,000 Daltons, less than about 500,000 Daltons, or less than about 250,000 Daltons, as measured by size exclusion chromatography using low angle laser light scattering. As used herein, the term “molecular weight” means the weight average molecular weight.

Other additives may be incorporated into the interlayer to enhance its performance in a final product and impart certain additional properties to the interlayer as long as the additives do not adversely affect the color and other properties desired. Such additives include, but are not limited to, adhesion control agents (“ACAs”), dyes, other pigments (such as color pigments or titanium dioxide), stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

In various embodiments of interlayers of the present disclosure, the interlayer will comprise about 5 to about 100 phr (parts per hundred parts resin) total plasticizer. In embodiments, the interlayer may comprise at least 10, at least 15, at least 20, at least 25, or at least 30 phr or more of plasticizer. In embodiments, the interlayer may comprise less than 95, less than 90, less than 85, less than 80, less than 75, less than 70, less than 65, less than 60, less than 55 or less than 50 phr of plasticizer. As used herein, the amount of plasticizer, or any other component in the interlayer, can be measured as parts per hundred parts resin (phr), on a weight per weight basis. For example, if 30 grams of plasticizer is added to 100 grams of polymer resin, then the plasticizer content of the resulting plasticized polymer would be 30 phr. As used herein, when the plasticizer content of the interlayer is given, the plasticizer content is determined with reference to the phr of the plasticizer in the melt that was used to produce the interlayer.

Examples of suitable plasticizers for use in these interlayers include esters of a polybasic acid or a polyhydric alcohol, among others. Suitable plasticizers include, for example, triethylene glycol di-(2-ethylhexanoate) (“3GEH”), tetraethylene glycol di-(2-ethylhexanoate), triethylene glycol di-(2-ethylbutyrate), triethylene glycol diheptanoate, tetraethylene glycol diheptanoate, dihexyl adipate, dioctyl adipate, hexyl cyclohexyladipate, diisononyl adipate, heptylnonyl adipate, dibutyl sebacate, and mixtures thereof.

In some embodiments, the plasticizer is 3GEH.

In other embodiments, a high refractive index plasticizer may be used, either alone or in combination with another plasticizer such as 3GEH. As used herein, a “high refractive index plasticizer” is a plasticizer having a refractive index of at least about 1.460. The refractive index of a commonly used plasticizer, such as 3GEH, is about 1.442, and the refractive indices of many other conventional plasticizers are from about 1.442 to about 1.449. Examples of plasticizers having a high refractive index that may be used in a polymer interlayer include, but are not limited to, polyadipates (RI of about 1.460 to about 1.485); epoxides such as epoxidized soybean oils (RI of about 1.460 to about 1.480); phthalates and terephthalates (RI of about 1.480 to about 1.540); benzoates (RI of about 1.480 to about 1.550); and other specialty plasticizers (RI of about 1.490 to about 1.520). The refractive index of poly(vinyl butyral) resin is approximately 1.485 to 1.495. Examples of high refractive index plasticizers include, but are not limited to, esters of a polybasic acid or a polyhydric alcohol, polyadipates, epoxides, phthalates, terephthalates, benzoates, toluates, mellitates and other specialty plasticizers, among others. Examples of suitable plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof. In some embodiments, examples of high refractive index plasticizers are dipropylene glycol dibenzoate, 2,2,4-trimethyl-1,3-pentanediol dibenzoate, and tripropylene glycol dibenzoate.

It is contemplated that polymer interlayer sheets as described herein may be produced by any suitable process known to one of ordinary skill in the art of producing polymer interlayer sheets that are capable of being used in a multiple layer panel (such as a glass laminate or glass panel). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminates of the present invention are formed using processes known in the art.

Generally, in its most basic sense, extrusion is a process used to create objects of a fixed cross-sectional profile. This is accomplished by pushing or drawing a material through a die of the desired cross-section for the end product. Generally, in the extrusion process, thermoplastic resin and plasticizers, including any of those resins, plasticizers and other additives described above, are pre-mixed and fed into an extruder device. Any additives such as colorants and UV inhibitors (in liquid, powder, or pellet form) are often used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material, plasticizer, pigment(s), and any other additives described above, are further mixed and melted, resulting in a melt that is generally uniform in temperature and composition. Once the melt reaches the end of the extruder device, the melt is propelled into the extruder die. The extruder die is the component of the thermoplastic extrusion process which gives the final polymer interlayer sheet product its profile. Generally, the die is designed such that the melt evenly flows from a cylindrical profile coming out of the die and into the product's end profile shape. A plurality of shapes can be imparted to the end polymer interlayer sheet by the die so long as a continuous profile is present.

The polymer interlayer at the state after the extrusion die forms the melt into a continuous profile will be referred to as a “polymer melt sheet.” At this stage in the process, the extrusion die has imparted a particular profile shape to the thermoplastic resin, thus creating the polymer melt sheet. The polymer melt sheet is highly viscous throughout and in a generally molten state. In the polymer melt sheet, the melt has not yet been cooled to a temperature at which the sheet generally completely “sets.” Thus, after the polymer melt sheet leaves the extrusion die, generally the next step in presently employed thermoplastic extrusion processes is to cool the polymer melt sheet with a cooling device. Cooling devices utilized in the previously employed processes include, but are not limited to, spray jets, fans, cooling baths, and cooling rollers. The cooling step functions to set the polymer melt sheet into a polymer interlayer sheet of a generally uniform non-molten cooled temperature. In some embodiments, the polymer melt sheet may be embossed after leaving the die, and prior to the cooling step, as previously discussed. In contrast to the polymer melt sheet, this polymer interlayer sheet is not in a molten state and is not highly viscous. Rather, it is the set final-form cooled polymer interlayer sheet product. For the purposes of this application, this set and cooled polymer interlayer will be referred to as the “polymer interlayer sheet.”

In some embodiments of the extrusion process, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

Generally, the thickness, or gauge, of the polymer interlayer sheet or any of the layers or interlayers can be at least about 2, at least about 5, at least about 10, at least about 15, at least about 20 mils and/or not more than about 120, not more than about 100, not more than about 90, not more than about 60, not more than about 50, or not more than about 35 mils, or it can be in the range of from about 2 to about 120, about 10 to about 100, about 15 to about 60, or about 20 to about 35 mils, although other thicknesses may be appropriate depending on the desired properties and/or application. In millimeters, the thickness of the polymer layers or interlayers can be at least about 0.05, at least about 0.13, at least about 0.25, at least about 0.38, at least about 0.51 mm and/or not more than about 2.74, not more than about 2.54, not more than about 2.29, not more than about 1.52, or not more than about 0.89 mm, or in the range of from about 0.05 to 2.74, about 0.25 to about 2.54 mm, about 0.38 to about 1.52 mm, or about 0.51 to about 0.89 mm, although other thicknesses may be appropriate depending on the desired properties and/or application.

As noted above, the interlayers of the present disclosure may be used as a single-layer sheet or a multilayered sheet. The interlayers having improved or lower yellow color may be used with one or more clear or colored interlayers to provide the desired laminate color(s) and appearance. In various embodiments, the interlayers of the present disclosure (either as a single-layer sheet, a multilayered sheet, or as one or more layers of the same or different materials) can be incorporated into a multiple layer panel, such as a transparent multiple layer panel with various types of glass, such as low iron glass or standard float glass.

As used herein, a multiple layer panel can comprise a single substrate, such as glass, acrylic, or polycarbonate with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements, such as infrared absorption characteristics. Poly(ethylene terephthalate) (“PET”) is the most commonly used polymer film.

The interlayers of the present disclosure will most commonly be utilized in multiple layer panels comprising two substrates, preferably a pair of glass sheets (or other rigid materials, such as polycarbonate or acrylic, known in the art), with the interlayers disposed between the two substrates. An example of such a construct would be: (glass)//(polymer interlayer sheet)//(glass), where the polymer interlayer sheet can comprise multilayered interlayers or multiple different single or multilayer interlayers, as noted above, and wherein at least one of the polymer interlayers (or layers therein) comprises the improved interlayer. These examples of multiple layer panels are in no way meant to be limiting, as one of ordinary skill in the art would readily recognize that numerous constructs other than those described above could be made with the interlayers of the present disclosure.

A typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time, such as at a temperature of about 70° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly, for example at temperatures between 135° C. and 150° C. and pressures between 150 psig and 200 psig for about 30 to 90 minutes.

One parameter often used to describe the polymer interlayers is the clarity, which is determined by measuring the haze value or percent haze (% Haze). Light that is scattered upon passing through a film or sheet of a material can produce a hazy or smoky field when objects are viewed through the material. Thus, the haze value is a quantification of the scattered light by a sample in contrast to the incident light. The test for percent haze is performed with a spectrophotometer such as the Ultrascan XE or Ultrascan PRO available from Hunter Associates (Reston, Va.), and in accordance with ASTM D1003-13 Procedure B using Illuminant C, at an observer angle of 2 degrees.

The interlayers of the present disclosure also have a luminous transmittance (% T) of at least 85% or at least 86% or from at least 85 to 95% or more (as measured on the HunterLab Ultrascan XE) depending on PVB thickness and the type of glass used. In embodiments, the % T may be at least 86%, at least 87%, at least 88%, at least 89%, or at least 90% or more. In embodiments, the interlayers of the present invention desirably have a* of about −0.2 and b* of about 0.4 when the interlayer is a single or mono layer (having a target or nominal thickness of 0.76 mm). Other values may be possible depending on the desired level of color, thickness, end use as well as other factors.

### EXAMPLES

Samples of interlayer sheet having lower yellow color were produced by mixing and melt extruding PVB resin, plasticizer, and colorants, along with other common additives (including adhesion control agents and a UV stabilizer). The mix was extruded to form interlayer sheets having a target or nominal thickness of about 0.76 mm (30 gauge (30 mils)).

To test the resultant interlayers, multiple layers of disclosed visually color neutral, commercially available clear and comparative low YI PVB interlayers were stacked and pressed to form a target thickness for measurement of YI, % T and L*a*b* values. To make an interlayer having a target or nominal thickness of about 6.3 mm, ten (10) layers were stacked together. For a target thickness of 3.8 mm, five (5) layers were stacked, and for a target thickness of 1.52 mm, two (2) layers were stacked. The stacked interlayers were then pressed together to the target thickness, as further described below. Measurements were also made on single layers of PVB (having a target or nominal thickness of 0.76 mm) as shown below. The actual PVB thickness of each interlayer measured is as noted in the Tables. In some cases, if mentioned in the table, values were corrected for PVB thickness, as further described below.

In some Tables, the properties of the PVB interlayers (without glass) are displayed. These values were obtained by collecting the data on the PVB sample (of the thickness noted in the Tables) without any glass being present during measurement of the samples. In other Tables, measurements were made on the glass laminates (PVB samples laminated between two pieces of glass (standard float glass or low iron glass as noted below)).

The following procedure (Procedure 1) was used to obtain the PVB samples at the desired thicknesses for measurement. To obtain a PVB sample of desired thickness (other than a single or monolayer sheet), multiple layers of PVB were pressed (or autoclaved) between two glass plates (as is custom and known to one skilled in the art). The PVB layers were first stacked (2, 5 or 10 layers) and placed between two pieces of glass with the addition of a polyester (PET or other similar material) sheet (that will not adhere to the PVB or glass) placed at each glass/PVB interface to allow the glass to be peeled away from the PVB sheet for measurement after the PVB is pressed to the desired thickness (of nominal 6.3, 3.8 or 1.52 mm). The stack had the following configuration: Glass/PET/PVB/PET/Glass. Once the stack was pressed or autoclaved, the glass and PET sheets were removed by peeling them away from the PVB, leaving the pressed PVB sample without glass. The PVB samples were then measured as described below.

For measurements made in glass laminates (or glazings), standard lamination procedures known to one skilled in the art were used as described below (Procedure 2). The interlayer(s) (or stack of two or five layers) was placed between two glass pieces of the desired type (low iron float or standard float) and size, it was pre-pressed to remove air, and then laminated. For the ten layer samples, the interlayers were placed between two glass pieces of the desired size and type and placed between a mechanical press and fused together to the target thickness of PVB. The laminate stack had the following configuration: Glass/PVB/Glass. The laminates were then measured as described below.

The glass color and PVB color were measured and calculated by the same methods according to ASTM method E1348, III. D65/10° Obs. CIELab. and ASTM E308. YI was measured and calculated according to methods ASTM E1348 and E313 using Illuminant C, at an observer angle of 2 degrees (formerly D1925). Haze (% Haze) and luminous transmittance (% T) were measured according to ASTM D1003-13 Procedure B using Illuminant C, at an observer angle of 2 degrees. Glass and PVB thickness were measured with calibrated sliders (but could be measured using any method or device known in the art) used for thickness measurement.

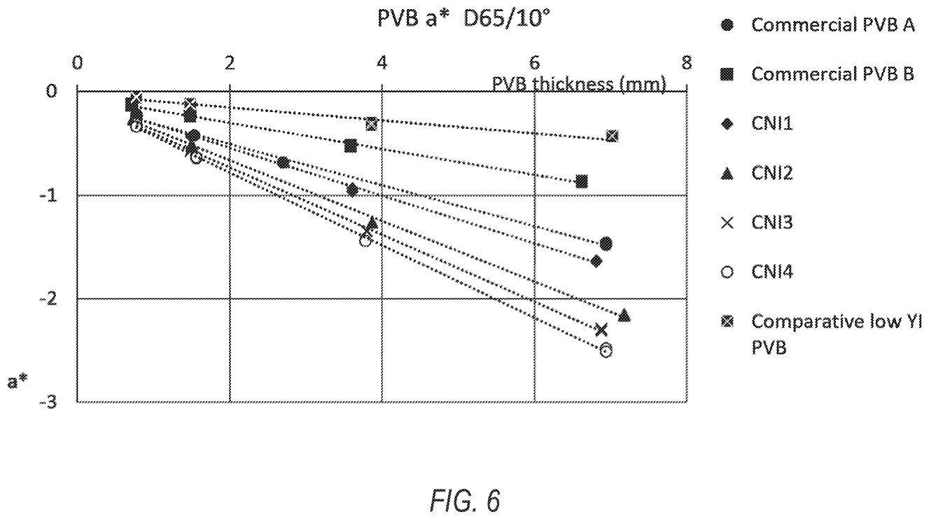

Table 1 shows the color properties of standard, commercially available PVB using 10 layers in combination with two different types of glass (4 mm low iron float glass or 2 mm standard clear float glass) as well as the color properties for single or monolayer PVB samples in combination with low iron clear float glass. The laminates were made using Procedure 2 described above. The measured YI was corrected for PVB thickness as follows: [YI_{corrected}=(YI_{measured}*nominal thickness)/PVB thickness]. A correction for thickness could be applied similarly for L*, a*, b* and % T if desired. As shown in FIGS. 6, 7 and 8, the a*, b* and % T values scale in a manner that is linearly proportional to PVB thickness. When the PVB interlayer is thicker, the b* values are higher, and a*, L* and % T are lower. For each laminate type, samples with the same name (i.e., Std clear 1, Std clear 2) are the same material.

In Tables 1 to 6, the L*, a*, b* and % T values are not corrected to nominal PVB thickness. In Tables 1 and 3, YI is corrected to nominal thickness of 6.3 mm. In Tables 2 and 4 to 6, no correction for thickness is applied.

TABLE 1

| Commercial | | Glass | PVB | | | | | |
|---|---|---|---|---|---|---|---|---|
| clear | Glass | thickness | thickness | | | | | |
| PVB sample | type | (mm) | (mm) | YI | L* | a* | b* | % T |
| Std clear 1 | low iron | 3.9 | 6.06 | 5.7 | 95.77 | −1.37 | 3.58 | 89.5 |
| Std clear 2 | clear | 3.9 | 5.99 | 6.9 | 95.65 | −1.42 | 4.25 | 89.2 |
| Std clear 3 | float | 3.9 | 5.98 | 7.7 | 95.31 | −1.56 | 4.75 | 88.4 |
| Std clear 4 | glass | 3.9 | 6.03 | 10.0 | 95.3 | −2.69 | 6.95 | 88.3 |
| Std clear 1 | clear | 2.2 | 6.00 | 4.3 | 95.13 | −2.46 | 3.34 | 88.0 |
| Std clear 2 | float | 2.2 | 6.00 | 5.3 | 94.75 | −2.51 | 4.10 | 87.0 |
| Std clear 3 | glass | 2.2 | 5.90 | 6.4 | 94.45 | −2.70 | 4.50 | 86.3 |
| Std clear 4 | | 2.2 | 6.00 | 9.0 | 94.63 | −3.84 | 6.85 | 86.7 |
| Std clear 1 | low iron | 3.9 | 0.76 | — | 96.30 | −0.49 | 0.63 | 90.7 |
| Std clear 2 | clear | 3.9 | 0.76 | — | 96.25 | −0.50 | 0.72 | 90.6 |
| Std clear 3 | float | 3.9 | 0.76 | — | 96.27 | −0.55 | 0.82 | 90.7 |
| Std clear 4 | glass | 3.9 | 0.76 | — | 96.23 | −0.90 | 1.53 | 90.6 |

As shown by the data in Table 1, the glass laminates with PVB having a target thickness of 6.3 mm have a* values of −1.4 to −2.7 and b* values of 3.6 to 7.0 when laminated in low iron glass. With standard clear float glass (6.3 mm target PVB thickness), a* values are lower, ranging of from −2.5 to −3.8, while the b* values remain about the same. The lower a* values with standard clear float glass indicate that the color of the laminate in standard clear float glass is somewhat greener compared to laminates made with low iron glass. This is also to be expected based on the color of the glass itself.

Table 2 shows the glass color (L*a*b*) for different types and thicknesses of glass.

TABLE 2

| | Glass thickness | | | |
|---|---|---|---|---|
| Glass type | (mm) | L* | a* | b* |
| standard clear float glass | 2.2 | 96.21 | −0.62 | 0.13 |
| standard clear float glass | 2.2 | 96.23 | −0.60 | 0.12 |
| 4 mm low iron glass | 3.9 | 96.55 | −0.18 | 0.14 |
| 4 mm low iron glass | 3.9 | 96.54 | −0.17 | 0.14 |
| 6 mm low iron glass | 5.8 | 96.36 | −0.23 | 0.07 |
| 6 mm low iron glass | 5.8 | 96.37 | −0.22 | 0.07 |

The a* and b* color data in Table 1 are common a* and b* values for laminate samples with standard commercially available PVB interlayers. The PVB has a yellow color (or high yellowness index) as shown by YI values ranging from about 4.0 to 10.0. Interlayers having lower YI values than those used in laminates and measured in Table 1 may exist but were not readily available and tested.

Further in Table 1, the color of laminates made with standard, commercially available clear PVB using 1 layer of PVB in combination with 4 mm low iron glass follows the same trend as for the ten-layer samples. The differentiation between samples having only one layer of PVB is less clear as the signal to noise ratio is much smaller for lower PVB thickness. Stated differently, using a thicker layer or sample of PVB provides better differentiation between samples when measuring the color.

Samples of comparative low YI interlayer having reduced color (lower yellowness or YI) and a* and b* both close to 0 and lower % T were produced as described above except that additional colorants were added in amounts sufficient to reduce the yellow color, as previously described. Table 3 shows the properties of the comparative interlayers prepared according to Procedure 2 with 2 mm thick clear float glass as described above.

TABLE 3

| | | Glass | | | | | | |
|---|---|---|---|---|---|---|---|---|
| | Glass | thickness | PVB | YI | | | | |
| Sample | type | (mm) | Thickness | corrected | L* | a* | b* | % T |
| Low YI | clear | 2.2 | 5.91 | 0.7 | 91.42 | −1.65 | 1.07 | 79.4 |
| Low YI | float | 2.2 | 6.02 | 0.5 | 91.32 | −1.58 | 0.92 | 79.3 |
| Low YI | glass | 2.2 | 5.98 | −0.2 | 90.5 | −1.51 | 0.6 | 77.3 |
| Low YI | | 2.2 | 0.76 | — | 95.19 | −1.3 | 0.3 | 88.1 |
| Low YI | | 2.2 | 0.75 | — | 95.21 | −1.28 | 0.32 | 88.1 |

As shown in Table 3, the a* and b* values of samples with comparative low YI PVB are lower than the values shown in Table 1 for samples with the same glass type and the same thicknesses of commercially available PVB, showing that the comparative PVB is less yellow than the commercially available PVB. The comparative PVB also has lower L* and lower % T values (less than 80% for the nominal 6.3 mm thickness PVB) than the commercially available PVB which shows that by reducing the yellowness, the % T and L* values were also reduced to levels that may be undesirable in some applications where high levels of transmission (% T) necessary.

Table 4 shows data collected on commercially available and comparative low YI PVB samples (single and ten layer) directly, without any glass being present (according to Procedure 1 described above). The absolute numbers (L*a*b*) are different from the numbers when measured on samples laminated between two pieces of glass. When PVB samples are measured directly there is an absence of glass color contribution, and PVB and glass have different reflective properties. The main trends for the L*, a* and b* values are similar for both laminated and unlaminated samples. For both types of samples, the color is much more pronounced at higher PVB thicknesses for standard commercially available clear PVB and for comparative low YI PVB. For both types of samples measured, L* and % T decrease with higher thickness, while YI and b* are less impacted.

TABLE 4

| | PVB | | | | | |
|---|---|---|---|---|---|---|
| Sample | Thickness | PVB YI | PVB L* | PVB a* | PVB b* | PVB % T |
| Std clear | 0.77 | 1.2 | 96.9 | −0.25 | 0.75 | 92.2 |
| Std clear | 6.94 | 6.9 | 96.38 | −1.60 | 4.30 | 90.9 |
| low YI | 0.77 | 0.4 | 95.98 | −0.05 | 0.41 | 90.0 |
| low YI | 7.02 | 0.8 | 91.97 | −0.08 | 0.60 | 80.6 |

Tables 5 and 6 show the properties of the disclosed visually color neutral (lower yellow color) PVB (ON PVB) samples in both laminated form with 4 mm low iron glass (Table 5) and without any glass present (Table 6) using ten, five, two or one layer(s) prepared according to Procedures 1 and 2 described above. Samples labeled ON 1 to 4 are different formulations having different amounts or levels of colorants to tune or change the a* and b* values as described above and shown in FIG. 9.

TABLE 5

| | | Glass | PVB | | | | | | |
|---|---|---|---|---|---|---|---|---|---|
| PVB | Glass | thickness | Thickness | | | | | | |
| Sample | type | (mm) | (mm) | YI | L* | a* | b* | % T | % Haze |
| std clear | low iron | 3.9 | 0.75 | 0.8 | 96.21 | −0.56 | 0.70 | 90.5 | 0.2 |
| std clear | clear | 3.9 | 1.46 | 1.4 | 96.15 | −0.73 | 1.16 | 90.4 | 0.2 |
| std clear | float | 3.9 | 3.85 | 3.2 | 95.90 | −1.19 | 2.47 | 89.8 | 0.4 |
| std clear | glass | 3.9 | 5.83 | 4.9 | 95.76 | −1.50 | 3.62 | 89.4 | — |
| CN 1 | | 3.9 | 0.76 | 0.4 | 96.24 | −0.59 | 0.55 | 90.6 | 0.1 |
| CN 1 | | 3.9 | 1.53 | 0.8 | 96.12 | −0.80 | 0.89 | 90.3 | 0.1 |
| CN 1 | | 3.9 | 3.79 | 1.7 | 95.76 | −1.32 | 1.70 | 89.4 | 0.2 |
| CN 1 | | 3.9 | 5.86 | 2.7 | 95.36 | −1.79 | 2.57 | 88.5 | — |
| CN 2 | | 3.9 | 0.75 | 0.2 | 96.09 | −0.66 | 0.46 | 90.2 | 0.3 |
| CN 2 | | 3.9 | 1.44 | 0.3 | 96.02 | −0.91 | 0.72 | 90.1 | 0.4 |
| CN 2 | | 3.9 | 3.85 | 0.7 | 95.45 | −1.59 | 1.33 | 88.7 | 0.3 |
| CN 2 | | 3.9 | 5.88 | 1.2 | 94.78 | −2.18 | 1.96 | 87.1 | — |
| CN 3 | | 3.9 | 0.74 | −0.1 | 96.25 | −0.68 | 0.31 | 90.6 | 0.1 |
| CN 3 | | 3.9 | 1.53 | −0.2 | 96.01 | −0.96 | 0.46 | 90.0 | 0.1 |
| CN 3 | | 3.9 | 3.89 | −0.4 | 95.16 | −1.74 | 0.80 | 88.0 | 0.2 |
| CN 3 | | 3.9 | 5.78 | −0.4 | 94.58 | −2.35 | 1.12 | 86.6 | — |
| CN 4 | | 3.9 | 0.76 | −0.1 | 96.10 | −0.69 | 0.30 | 90.3 | 0.1 |
| CN 4 | | 3.9 | 1.53 | −0.3 | 95.93 | −1.01 | 0.37 | 89.8 | 0.2 |
| CN 4 | | 3.9 | 3.89 | −1.0 | 94.98 | −1.94 | 0.41 | 87.6 | 0.2 |
| CN 4 | | 3.9 | 5.79 | −1.3 | 94.32 | −2.48 | 0.75 | 86.0 | — |

Table 5 shows that the laminates having a PVB nominal thickness of 6.3 mm (in 4 mm low iron glass) all have luminous transmittance (% T) values of at least 86%, and L* values of greater than 94. At a nominal thickness of 3.8 mm (in 4 mm low iron glass) all laminates containing the disclosed samples have a % T of at least about 87.5% and L* values of greater than about 95.0. Laminates having a nominal PVB thickness of 1.52 mm (in 4 mm low iron glass) all have a % T of at almost 90%, and L* values of almost 96, and laminates with a PVB sample having a nominal thickness of 0.76 mm (in 4 mm low iron glass) all have a % T of greater than 90% and L* values of greater than 96. All of the disclosed PVB samples at all thicknesses have a* values of less than 0 and b* values of greater than 0. Specifically, the laminates with PVB samples with target 6.3 mm thickness have a* values ranging from −1.79 to −2.48 and PVB b* values ranging from 0.75 to 2.57. At 3.8 mm target thickness, laminate a* values range from −1.32 to −1.94 and b* values range from 0.41 to 1.70. For the 1.52 mm PVB samples, a* values range from −0.80 to −1.01 and PVB b* values range from 0.37 to 0.89, while for the PVB samples having a nominal thickness of 0.76 mm, a* values range from −0.59 to −0.69 and PVB b* values range from 0.30 to 0.55. In addition, Table 5 shows that all the disclosed samples have excellent low haze values (haze <0.4% for the four disclosed CN formulations) which is similar to laminates containing standard commercially available clear PVB interlayers.

TABLE 6

| | PVB | | | | | |
|---|---|---|---|---|---|---|
| Sample | Thickness | YI | PVB L* | PVB a* | PVB b* | % T |
| CN 1 | 0.78 | 0.7 | 96.93 | −0.24 | 0.54 | 92.3 |
| CN 1 | 1.49 | 1.1 | 96.79 | −0.43 | 0.83 | 92.0 |
| CN 1 | 3.61 | 1.9 | 96.33 | −0.95 | 1.60 | 90.8 |
| CN 1 | 6.81 | 3.0 | 95.98 | −1.64 | 2.66 | 90.0 |
| CN 2 | 0.73 | 0.5 | 96.86 | −0.27 | 0.46 | 92.1 |
| CN 2 | 1.50 | 0.7 | 96.68 | −0.52 | 0.69 | 91.7 |
| CN 2 | 3.87 | 1.0 | 96.05 | −1.26 | 1.34 | 90.1 |
| CN 2 | 7.18 | 1.3 | 95.20 | −2.16 | 2.05 | 88.1 |
| CN 3 | 0.78 | 0.4 | 96.77 | −0.32 | 0.36 | 91.9 |
| CN 3 | 1.48 | 0.3 | 96.54 | −0.57 | 0.48 | 91.3 |
| CN 3 | 3.80 | 0.0 | 95.80 | −1.35 | 0.79 | 89.5 |
| CN 3 | 6.88 | −0.6 | 94.82 | −2.30 | 1.07 | 87.1 |
| CN 4 | 0.77 | 0.2 | 96.48 | −0.33 | 0.26 | 91.2 |
| CN 4 | 1.56 | 0.0 | 96.44 | −0.64 | 0.36 | 91.0 |
| CN 4 | 3.78 | −0.8 | 95.69 | −1.44 | 0.45 | 89.2 |
| CN 4 | 6.94 | −1.8 | 94.53 | −2.50 | 0.49 | 86.3 |

Table 6 shows that the disclosed visually color neutral samples having a PVB nominal thickness of 6.3 mm all have % T values of at least 86% and L* values of greater than 94.5. At a nominal thickness of 3.8 mm, all the disclosed PVB samples have a % T of minimum about 89% and L* values of greater than about 95.5. Samples having a nominal PVB thickness of 1.52 mm all have a % T of at least 91% and L* values of greater than 96.4, and samples having a nominal thickness of 0.76 mm all have a % T of greater than 91.1% and L* values of greater than 96. All the PVB samples at all thicknesses have a* values of less than 0 and b* values of greater than 0. Specifically, in samples with a target 6.3 mm thickness, the PVB a* values range from −1.64 to −2.50 and PVB b* values range from 0.49 to 2.66; at 3.8 mm target thickness, PVB a* values range from −0.95 to −1.44 and PVB b* values of range from 0.45 to 1.60; at 1.52 mm nominal thickness, PVB a* values range from −0.43 to −0.64 and PVB b* values range from 0.36 to 0.83; and finally for PVB samples having a nominal thickness of 0.76 mm, PVB a* values range from −0.24 to −0.33 and PVB b* values range from 0.26 to 0.54.

As shown in Tables 5 and 6, at all thicknesses, the disclosed visually color neutral PVB samples have higher L* and % T values than the commercially available clear and comparative low YI PVB samples in Tables 1 and 3. The % T of the disclosed visually color neutral PVB is higher (86.3% compared to only 80.6% at 6.3 mm PVB thickness for the comparative low YI PVB) while also achieving low yellow color due to relatively low PVB a* and b* values.

The % T and color data in Tables 5 and 6 (and as shown in FIGS. 6 to 8) show that it is possible to control the visual color with limited impact on luminous transmittance (% T) by addition of colorants to provide a polymer interlayer having improved color and a visually color neutral appearance. As shown in FIGS. 6 to 8, PVB a* and b* values for the disclosed interlayers are in a distinctly different range compared to the standard commercially available clear and comparative low YI PVB. The improved neutral color interlayer has a lower yellow color and improved appearance compared to standard, commercially available interlayers as well as other comparative lower yellow color interlayers.

In conclusion, the polymer interlayers having lower yellow color as described herein have advantages over polymer interlayers that have higher levels of color as they can be more aesthetically pleasing. Other advantages will be readily apparent to those skilled in the art.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizer in any of the ranges given to form many permutations that are within the scope of the present disclosure, but that would be cumbersome to list. Further, ranges provided for a genus or a category can also be applied to species within the genus or members of the category unless otherwise noted.

1. A poly(vinyl butyral) interlayer comprising:
poly(vinyl butyral) resin and at least one plasticizer,
wherein the interlayer has color coordinates L*, a* and b* and a luminous transmittance (% T) when measured on a sample with a target thickness of 6.3 mm prepared according to Procedure 1 such that L*>94, −2.5<a*<−1.0, 0<b*<2.5, and % T≥85%, wherein L*, a* and b* are measured according to ASTM E1348 III. D65/10° Obs. CIELab, and % T is measured according to ASTM D1003).

2. The poly(vinyl butyral) interlayer of claim 1, wherein the interlayer has color coordinates L*, a* and b* when measured on a sample with a target thickness of 6.3 mm prepared according to Procedure 1 such that L*>94, −2.5<a*<−1.1, 0<b*<2.5, and % T≥85%, wherein L*, a* and b* are measured according to ASTM E1348 III. D65/10° Obs. CIELab, and % T is measured according to ASTM D1003).

3. The poly(vinyl butyral) interlayer of claim 1, wherein the interlayer has color coordinates L*, a* and b* when measured on a sample with a target thickness of 6.3 mm prepared according to Procedure 1 such that L*>94, −2.3<a*<−1.2, 0.5<b*<2.4, wherein L*, a* and b* are measured according to ASTM E1348 III. D65/10° Obs. CIELab.

4. The poly(vinyl butyral) interlayer of claim 1, wherein the interlayer has color coordinates L*, a* and b* when measured on a sample with a target thickness of 6.3 mm prepared according to Procedure 1 such that L*>94, −2.2<a*<−1.3, 0.5<b*<2.2, wherein L*, a* and b* are measured according to ASTM E1348 III. D65/10° Obs. CIELab.

5. The poly(vinyl butyral) interlayer of claim 1, wherein the interlayer has color coordinates L*, a* and b* when measured on a sample with a target thickness of 6.3 mm prepared according to Procedure 1 such that L*>94, −2.0<a*<−1.5, 1.0<b*<2.0, wherein L*, a* and b* are measured according to ASTM E1348 III. D65/10° Obs. CIELab.

6. The poly(vinyl butyral) interlayer of claim 1, wherein the interlayer has color coordinates L*, a* and b* when measured on a sample with a target thickness of 3.8 mm prepared according to Procedure 1 such that L*>95.5, −1.50<a*<−0.95 and 0<b*<1.5, wherein L*, a* and b* are measured according to ASTM E1348 III. D65/10° Obs. CIELab.

7. The poly(vinyl butyral) interlayer of claim 6, wherein the interlayer has a luminous transmittance (% T) when measured on a sample with a target thickness of 3.8 mm prepared according to Procedure 1 such that % T is at least 89%, wherein % T is measured according to ASTM D1003.

8. The poly(vinyl butyral) interlayer of claim 1, wherein the interlayer has color coordinates L*, a* and b* when measured on a sample with a target thickness of 1.52 mm prepared according to Procedure 1 such that L*>95.0, −0.65<a*<−0.45 and 0.1<b*<0.8, wherein L*, a* and b* are measured according to ASTM E1348 III. D65/10° Obs. CIELab.

9. The poly(vinyl butyral) interlayer of claim 8, wherein the interlayer has a luminous transmittance (% T) when measured on a sample with a target thickness of 1.52 mm prepared according to Procedure 1 such that % T is at least 91%, wherein % T is measured according to ASTM D1003.

10. The poly(vinyl butyral) interlayer claim 1, wherein the interlayer has color coordinates L*, a* and b* when measured on a sample with a target thickness of 0.76 mm prepared according to Procedure 1 such that L*>96.0, −0.35<a*<−0.25 and 0.05<b*<0.55, wherein L*, a* and b* are measured according to ASTM E1348 III. D65/10° Obs. CIELab.

11. The poly(vinyl butyral) interlayer of claim 10, wherein the interlayer has a luminous transmittance (% T) when measured on a sample with a target thickness of 0.76 mm prepared according to Procedure 1 such that % T is at least 90%, wherein % T is measured according to ASTM D1003.

12. The poly(vinyl butyral) interlayer of claim 1, wherein the interlayer is a multilayer interlayer having at least two layers.

13. The poly(vinyl butyral) interlayer of claim 1, wherein the interlayer is a multilayer interlayer having at least three layers.

14. A multilayer panel comprising:
a first glass substrate,
the interlayer of claim 1, and
a second glass substrate.

15. The multilayer glass panel of claim 14, wherein the first glass substrate and the second glass substrate each comprise low iron glass.

16. The multilayer glass panel of claim 14, wherein the first glass substrate and the second glass substrate each comprise standard float glass.

17. The multilayer glass panel of claim 14, wherein the first glass substrate has a thickness of at least 2 mm and the second glass substrate has a thickness of at least 2 mm.

18. A method for making an improved color poly(vinyl butyral) sheet comprising:
providing a poly(vinyl butyral) resin;
providing a plasticizer;
providing at least one colorant in an amount sufficient to reduce the yellow color aspect of the poly(vinyl butyral) sheet;
melt blending the poly(vinyl butyral) resin, the plasticizer and the colorant to create a poly(vinyl butyral) melt blend;
and extruding the poly(vinyl butyral) melt blend into a poly(vinyl butyral) sheet;
wherein the poly(vinyl butyral) sheet has color coordinates a* and b*, when measured on a sheet having a thickness of 6.3 mm (as measured according to ASTM E1348 III. D65/10° Obs. CIELab), of L*>94, −2.5<a*<−1.0 and 0<b*<2.5.

19. The method of claim 18, wherein the interlayer has a luminous transmittance (% T) when measured on a sample with a target thickness of 6.3 mm prepared according to Procedure 1 of % T≥85%, wherein % T is measured according to ASTM D1003).

20. The method of claim 18, wherein the interlayer has color coordinates L*, a* and b* when measured on a sample with a target thickness of 6.3 mm prepared according to Procedure 1 such that L*>94, −2.0<a*<−1.5, 1.0<b*<2.0, wherein a* and b* are measured according to ASTM E1348 III. D65/10° Obs. CIELab.
